(19) United States
(12) Patent Application Publication
(10) Pub. No.: US 2004/0119039 A1
(43) Pub. Date: Jun. 24, 2004

(54) Bistable converter in a spray dampening system

(76) Inventors: Michael A. Nierniro, Chicago, IL (US); Robert J. Magyar, Elk Grove Village, IL (US)

Correspondence Address: BARNES & THORNBURG, P.O. BOX 2786, CHICAGO, IL, 60690-2786, US

(21) Appl. No.: 10/667,255

(22) Filed: Sep. 19, 2003

Related U.S. Application Data
(60) Provisional application No. 60/412,509, filed on Sep. 20, 2002.

(51) Int. Cl. F16K 31/02

(52) U.S. Cl. 251/129.2

(57) ABSTRACT

A system used to interface between the drive stage of a unipolar spray dampening control system, and a bipolar valve. The system converts from an input, whose duty cycle is governed by pulse width modulation, to one in which the pulse width is constant and the frequency varied. If the duty cycle conversion is not required, the system can operate in follower mode which allows the converter outputs to follow the input frequency. Also disclosed is a method of controlling a magnetically actuated bistable valve. The method involves receiving a unipolar signal and converting the unipolar signal to a bistable signal. The bistable signal is then sent to a bistable valve causing it to shift from its current state to an opposite state. A state is either a closed or open valve position. The state can be switched again by reversing the current.

### BACKGROUND OF THE INVENTION

Thousands of spray dampeners have been sold in the past. Many more are currently being installed. Many spray dampeners are limited by their inability to integrate with more sophisticated equipment.

Contemporary spray dampening systems employ unipolar valves, which are energized in only one direction. A unipolar device requires electrical energy on only one direction, or one phase of the unipolar device's operating cycle, to move an actuator. Once electrical energy is removed, a mechanical component such as spring or elastomer returns the actuator to it's normal state. Furthermore, the majority of the existing systems vary the pulse width (on-time) applied to the valve to make adjustments, which does not allow optimal performance.

A bipolar device uses electrical energy to return the actuator back to normal position. A mechanical device, such as a spring may be present, but it is not the primary locomotive force.

### SUMMARY OF THE INVENTION

The present disclosure is for a system used to interface between the drive stage of a unipolar spray dampening control system, and a bipolar valve. Further, it converts from an input, whose duty cycle is governed by pulse width modulation, to one in which the pulse width is constant and the frequency varied. If the duty cycle conversion is not required, the present system can operate in follower mode. This mode allows the converter outputs to follow the input frequency.

Also disclosed is a method of controlling a magnetically actuated bistable valve. The method involves receiving a unipolar signal and converting the unipolar signal to a bistable signal. The bistable signal is then sent to a bistable valve causing it to shift from its current state to an opposite state. A state is either a closed or open valve position. The state can be switched again by reversing the current. This switching may be repeated as needed for various printing applications.

### BRIEF DESCRIPTION OF THE DRAWINGS

The detailed description particularly refers to the accompanying figures in which:

FIG. 1 is a simplified diagram of the a bistable valve of the present disclosure in an initial un-energized state;

FIG. 2 is a simplified diagram of a bistable valve after a current has been produced in a first direction;

FIG. 3 is a simplified diagram of a bistable valve after a current has been produced in second direction, the second direction being opposite the first direction; and

### DETAILED DESCRIPTION OF THE ILLUSTRATED EMBODIMENT

The apparatus and method of the present invention may be embodied in other specific forms without departing from the spirit of the described embodiments. Thus, the illustrated and described embodiment should be considered as illustrative, and not for the purpose of restricting the scope of the present invention. The scope of the present invention is indicated by the claims set forth below, and all modifications that come within the meaning, range and/or equivalency of the appended claims are intended to be embraced within the meaning of the claims.

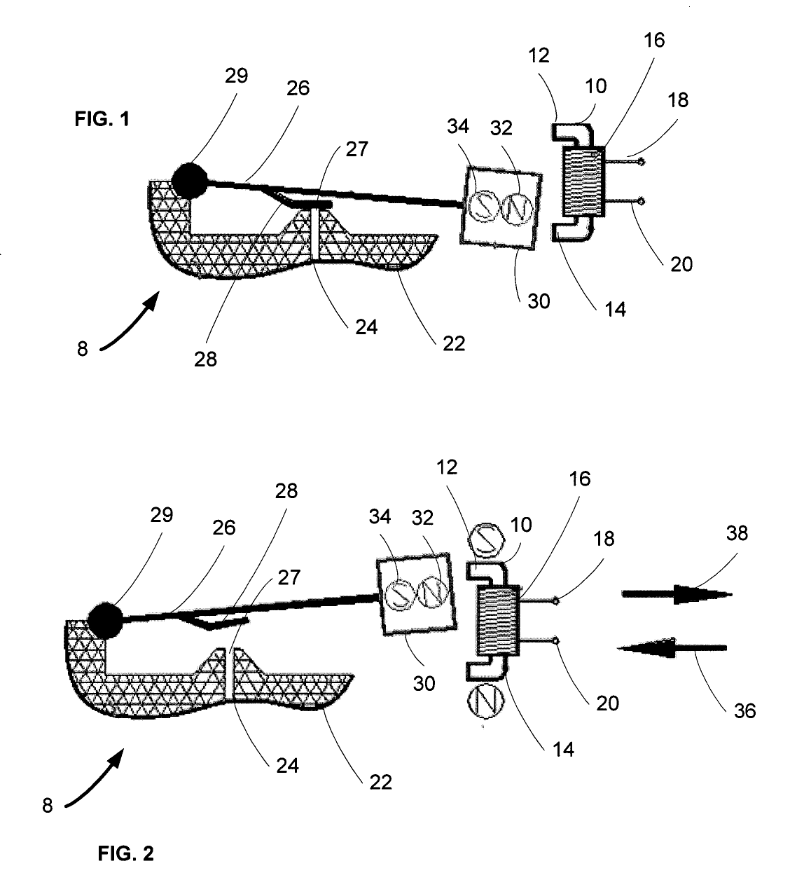

With reference to the figures, FIG. 1 shows a simplified diagram of one of bistable valve 8 that may be used in the current system, although other bistable valves may be used. Valve 8 includes a flux bracket 10 having a first or top end 12 and second or bottom end 14. References to “top” and “bottom” are used to describe the orientation corresponding with the figures. The orientation of flux bracket 10 may be reversed or lay horizontally or at angle and still be within the scope of this disclosure. A wire coil 16 is wrapped around flux bracket 10 with a first wire end 18 and second wire end 20 extending therefrom toward a signal converter to be described below.

Valve 8 also includes a valve seat 22 through which an input tube 24 directs a desired fluid, such as printing ink where the current system is used in a printing application. Fluid flows through input tube 24 and out valve 8 unless an armature 26 is in a position to cause closing member 28 to block flow at tube opening 27. Armature 26 is pivotally attached to valve seat 22 at pivot member 29. The total distance an end of armature 26 is able to pivot from an open to closed state is generally proportional to the distance from top end 12 to bottom end 14.

A magnet 30 is attached to an end of aperture 26. Magnet 30 is polarized such that magnet end 32 has either a north or south polarity and second magnet end 34 has an opposite polarity. Although magnetic end 32 is shown to have a north polarity in FIG. 1, the polarity may be switched, thus switching the polarity of second magnet end 34.

FIG. 1 shows the valve 8 with no current passing through coil 16. No magnetic field is produced by the coil therefore top and bottom ends 12, 14 have no magnetic polarity.

As shown in FIG. 2, in operation, a current is provided in a first direction through coil 16 via wire ends 18, 20. The direction shown in FIG. 2 is to provide a current into end 20, through coil 16, and out of end 18 is a first current direction. The current causes the coil to produce a magnetic field creating a south polarity in the top end 10 and a north polarity in bottom end 14. Magnet end 32 is magnetically attracted to magnetized top end 12 creating a force to move aperture 26, and consequently closing member 28, away from opening 27 allowing fluid to flow therethrough.

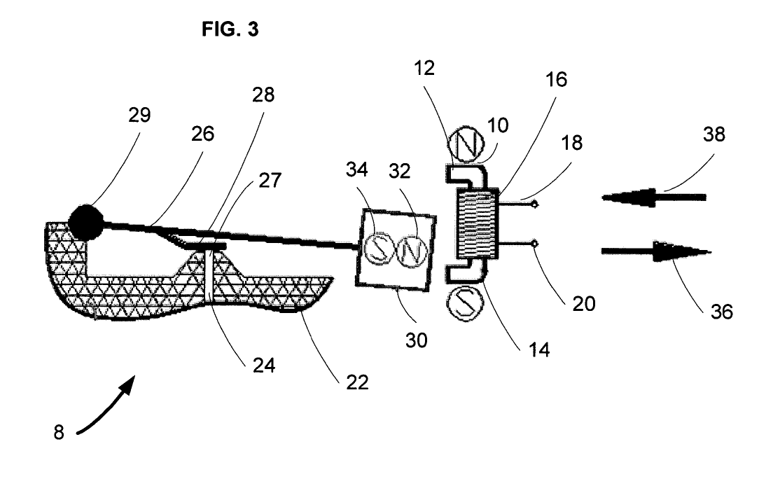

As shown in FIG. 3, by reversing the current's direction by having current flow into wire end 18 and out of wire end 20, i.e. a second current direction that is opposite the first current direction, an opposite magnetic field is produced which reverses the polarities of top and bottom 12, 14. Magnet end 32 is attracted to bottom end 14 causing magnet 30, armature 26 and closing member 28 to move toward and close opening 27.

Use of this type of valve is advantageous because practically the only moving component is armature 26, which is of limited mass and a relatively small moment of inertia. Furthermore, armature 26 generally is not in contact with any surface that would impede motion, effectively eliminating any friction. The magnetic forces that operate the armature 26 are generally created and dissipate at a fast rate to allow the responsiveness needed for high speed operations such as spray dampening. The lack of additional mechanical parts also improves the longevity of the valve.

In operation, this functionality results in greater uniformity in circumferential laydown of fluids such as dampening solution as well as a more consistent spray pattern. This type of operation also results in faster, and shorter transitions from zero flow to full flow, and from full flow back to zero flow. This enhances the spray quality.

The signal to the valve 8 is produced using control and converter circuitry as shown in FIGS. 4-60 that operates as follows. An incoming pulse train arrives at the input to a bidirectional optical isolator (IN1). The coupled signal becomes OUT1. The output of the buffer, a 5V logic level version of the input signal, is fed into a processor. The processor calculates an input duty cycle by measuring the pulse width and frequency of the incoming signal. From this, the constant on-time frequency is calculated, and the information is transferred to a set of valve drivers. The processor then calculates a duty cycle according to the formula [DC=Pulse Width×Frequency]. The processor uses this same formula to create an output with equal or scaled duty cycle utilizing a pre-defined pulse width and a calculated frequency.

The processor (uP) delivers data to the drive circuit containing all pertinent information. The drive circuit delivers assigned current through the valve, and also through a current sensing circuit. This supplies feedback to the drive circuit to allow compensation, thereby regulating the current through the valve.

Optionally, there is a switch bank on the control circuitry that allows selection between a duty-cycle conversion mode and a follower mode. In follower mode, the device tracks the incoming frequency, acting primarily as a unipolar to bipolar converter.

The conversion between a unipolar to bipolar signal occurs because the “pulse width” creates an output of the converter consisting of current of one polarity at one edge, and current in the opposite polarity at the other edge.

Valve 8 may also have the following alternative embodiments. Valve 8 may employ a plunger style actuator rather than a lever style actuator. The previous embodiment illustrated use of one coil, in which the current is reversed to open and shut the valve. However, in an alternative embodiment, a valve can be used having a second coil which has opposing winding. Also, the magnet 30 was previously described as being actuated by an attractive magnetic force. It is envisioned that a repellant magnetic force, or combination of attractive and repellant magnetic forces can be used as well.

1. A system for controlling flow, the system comprising:
a signal converter for receiving a unipolar control signal and converting the unipolar control signal to a bipolar control signal; and
a magnetically actuated bistable valve in electrical communication with and responsive to the signal converter.

2. The system of claim 1, wherein the bistable valve is a lever valve;

3. The system of claim 2, wherein the lever valve comprises:
a flux bracket;
a coil wrapped around the flux bracket with a first end and second end of the coil electrically connected to the signal converting means;
a valve seat, the valve seat having an input tube extending through the valve seat;
an armature pivotally attached to a valve seat, the armature having a closing member for closing the input tube; and
a magnet at an end of the armature.

4. The system of claim 3, wherein the lever valve further comprises a second coil, the second coil wrapped around the flux bracket in an opposing winding pattern to the coil.

5. The system of claim 1, wherein the bistable valve is a plunger valve.

6. The system of claim 1, wherein the signal converter comprises:
a bidirectional optical isolator for receiving an input signal;
a Schmidt trigger inverting buffer responsive to and in electrical communication with the bidirectional optical isolator;
a processor in electrical communication with the Schmidt trigger inverting buffer.

7. The system of claim 6, wherein the bistable valve is a lever valve;

8. The system of claim 7, wherein the lever valve comprises:
a flux bracket;
a coil wrapped around the flux bracket with a first end and second end of the coil electrically connected to the signal converting means;
a valve seat, the valve seat having an input tube extending through the valve seat;
an armature pivotally attached to a valve seat, the armature having a closing member for closing the input tube; and
a magnet at an end of the armature.

9. A method of controlling a magnetically actuated bistable valve, the method comprising the steps of:
receiving a unipolar control signal and converting the unipolar control signal to a bipolar control signal;
as directed by the bipolar control signal, producing an electric current in a first direction and directing the electric current to the bistable valve to switch the bistable valve from a first state, the first state being one of an open state or closed state, to a second state that is opposite the first state; and
as directed by the bipolar control signal, producing a second electric current in a second direction, the second direction being opposite the first direction, and directing the electric current to the bistable valve to switch the bistable valve from the second state to the first state.

10. An apparatus for converting a unipolar control signal to a bipolar control signal, the apparatus comprising:
a bidirectional optical isolator for receiving an input signal;
a Schmidt trigger inverting buffer responsive to and in electrical communication with the bidirectional optical isolator;
a processor in electrical communication with the Schmidt trigger inverting buffer.
